(19) United States
(12) Patent Application Publication
(10) Pub. No.: US 2024/0170815 A1
(43) Pub. Date: May 23, 2024

(54) CELL WITH AN EXTERNAL WELDED STRUCTURE

(71) Applicant: Our Next Energy, Inc., Novi, MI (US)

(72) Inventors: Seong Woo Park, Commerce Township, MI (US); Jin Sub Park, Gyeonggi-do (KR)

(21) Appl. No.: 18/516,941

(22) Filed: Nov. 21, 2023

Related U.S. Application Data
(63) Continuation of application No. 63/427,133, filed on Nov. 22, 2022.

(51) Int. Cl. H01M 50/566; H01M 50/103; H01M 50/15; H01M 50/533; H01M 50/562

(52) U.S. Cl. CPC H01M 50/566; H01M 50/103; H01M 50/15; H01M 50/533; H01M 50/562

(57) ABSTRACT

A cell that includes a housing and a current collector with a protrusion. The cell also includes a cap assembly that closes the housing, the cap assembly including a terminal with a first opening, a second opening, and a terminal partition material separating the second opening from the first opening. The current collector is placed in the second opening and welded to the terminal at the first opening to form a terminal-to-current collector weld at an external area of the cell.

### BACKGROUND

### Technical Field

The present disclosure generally relates to battery cells and more particularly to a prismatic battery cell structure in which the terminal and the current collector are welded at the outside of the battery cell.

### Description of the Related Art

Battery cells are not only used in electronic equipment like mobile phones, digital cameras, portable computers and the like but also in a wide area of application in the aspects of large and medium-sized electric equipment such as electric vehicles, electric bicycles and energy storage facilities.

A cell generally comprises cathode and anode components, a current collecting member, an end cover assembly and a housing. Components may be assembled by welding, and the connection strength and location of the welding may affect the connection stability of the cell at a later stage.

### SUMMARY

According to an embodiment of the present disclosure, a cell with an external welded structure is provided. The cell has a housing and a current collector with a protrusion. The cell also includes a cap assembly that closes the housing. The cap assembly includes a terminal with a first opening, a second opening, and a terminal partition material separating the second opening from the first opening. The cap assembly also includes a cap plate. The current collector is placed in the second opening and welded to the terminal at the first opening to form a terminal-to-current collector weld at an external area of the cell. In one embodiment, the protrusion is a pillar shaped protrusion.

In one embodiment, the terminal further includes an upper plate, a middle insulator and a base plate, with the base plate being welded to the cap plate and the insulator electrically insulating the upper plate from the base plate.

In one embodiment, the cell further includes a current collector position fixing plate which has a fourth opening through which the protrusion is inserted.

According to an embodiment of the present disclosure, a cell is provided. The cell includes a current collector disposed in the housing with the current collector having a protrusion. The cell includes a cap assembly that includes a terminal with a hole and a cap plate. The cell may include a terminal hole cover covering the hole. The current collector is disposed in the hole and welded to the terminal at the terminal hole cover to form a terminal-to-current collector weld at an external area of the cell.

According to an embodiment of the present disclosure, a method of fabricating a cell with an extended welded structure is provided. The method includes providing a housing, a current collector having a protrusion, and a cap assembly including a terminal and a cap plate. In the method, a first opening is generated at a top side of the terminal, a second opening is generated at a bottom side of the terminal, and a terminal partition material is left to separate the second opening from the first opening. The housing is closed using the cap assembly by inserting a protrusion of the current collector into the second opening to place it adjacent to the terminal partition material. The terminal partition material is welded to the current collector from an area external to the cell and through the first opening, to generate a terminal-to-current collector weld.

In one embodiment, method includes adjusting a position of the current collector in the housing, prior to the closing the housing, using the current collector position fixing plate. The techniques described herein may be implemented in a number of ways. Example implementations are provided below with reference to the following figures.

### BRIEF DESCRIPTION OF THE DRAWINGS

To easily identify the discussion of any particular element or act, the most significant digit or digits in a reference number refer to the figure number in which that element is first introduced.

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1A depicts a perspective view of a cell in accordance with an illustrative embodiment.

FIG. 1B depicts a cross section of a cell after assembly in accordance with an illustrative embodiment.

FIG. 2 depicts an exploded view of a cap assembly and current collector in accordance with an illustrative embodiment.

FIG. 3A depicts a zoomed in view of a cross section of a cell in accordance with an illustrative embodiment.

FIG. 3B depicts a cross section of a cell showing a welding process.

FIG. 4 depicts a cross section of a cell in accordance with an illustrative embodiment.

FIG. 5 depicts a cross section of a cap assembly and current collector in accordance with an illustrative embodiment.

FIG. 6 depicts a cross section of a cell in accordance with an illustrative embodiment.

FIG. 7 depicts a cross section of a cell in accordance with an illustrative embodiment.

FIG. 8 depicts a routine in accordance with an illustrative embodiment.

FIG. 9 depicts stages of an assembly process in accordance with an illustrative embodiment.

FIG. 10 depicts a functional block diagram of a computer hardware platform in accordance with one embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, and/or components have been described at a relatively high-level, without detail, to avoid unnecessarily obscuring aspects of the present teachings.

In one aspect, spatially related terminology such as “front,” “back,” “top,” “bottom,” “beneath,” “below,” “lower,” above,” “upper,” “side,” “left,” “right,” and the like, is used with reference to the orientation of the Figures being described. Since components of embodiments of the disclosure can be positioned in a number of different orientations, the directional terminology is used for purposes of illustration and is in no way limiting. Thus, it will be understood that the spatially relative terminology is intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

As used herein, the terms “lateral” and “horizontal” describe an orientation parallel to a first surface of a cell. As used herein, the term “vertical” describes an orientation that is arranged perpendicular to the first surface of a cell.

As used herein, the terms “coupled” and/or “electrically coupled” are not meant to mean that the elements must be directly coupled together-intervening elements may be provided between the “coupled” or “electrically coupled” elements. In contrast, if an element is referred to as being “directly connected” or “directly coupled” to another element, there are no intervening elements present. The term “electrically connected” refers to an electric connection between the elements electrically connected together.

Although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

Example embodiments are described herein with reference to cross-sectional illustrations that are schematic illustrations of idealized or simplified embodiments (and intermediate structures). As such, variations from the shapes of the illustrations as a result, for example, of manufacturing techniques and/or tolerances, may be expected. Thus, the regions illustrated in the figures are schematic in nature and their shapes do not necessarily illustrate the actual shape of a region of a device and do not limit the scope.

It is to be understood that other embodiments may be used, and structural or logical changes may be made without departing from the spirit and scope defined by the claims. The description of the embodiments is not limiting. In particular, elements of the embodiments described hereinafter may be combined with elements of different embodiments.

For the sake of brevity, conventional techniques related to battery cells and their fabrication may or may not be described in detail herein. Moreover, the various tasks and process steps described herein can be incorporated into a more comprehensive procedure or process having additional steps or functionality not described in detail herein. In particular, various steps in the manufacture of cells are well known and so, in the interest of brevity, many conventional steps will only be mentioned briefly herein or will be omitted entirely without providing the well-known process details.

Turning now to an overview of technologies that generally relevant to the present teachings, a prismatic CAN battery cell and other cell types may have a structure for electrical connection between a current collecting part of electrode plates inside the battery cell and an external terminal created by a method such as ultrasonic welding or laser welding. The illustrative embodiments recognize that due to the inflow of foreign materials generated during the welding process, an internal short of the battery cell and thus a safety problem may be caused. For example, a current collector may be welded to an electrode assembly via a rivet structure which fixes the cell terminal onto the cap plate to form an electrical connection between the terminal and the electrode assembly. In such a structure, generated welds are located inside the battery cell and internal shorts, cell degradation and safety issues may occur due to the introduction of foreign substances generated during welding. Further, an empty space is usually generated in the battery cell to realize a welding structure which may fundamentally decrease an energy density of the cell. The illustrative embodiments further recognize that

The illustrative embodiments disclose a terminal structure configured to be welded outside a battery cell to a current collector structure. The illustrative embodiments also disclose a current collector position fixing plate configured to fix the position of a current collector during welding, thereby fundamentally controlling inflow of foreign materials generated during the welding process and minimizing a welding space to increase energy density of the battery cell.

Various non-limiting embodiments show terminal structures configured on a cap assembly that provide for a current collector protrusion part to be inserted at inner portion of the battery cell to interface with an engraved structure for sufficiently welding between the current collector and the terminal at an external area of the battery cell.

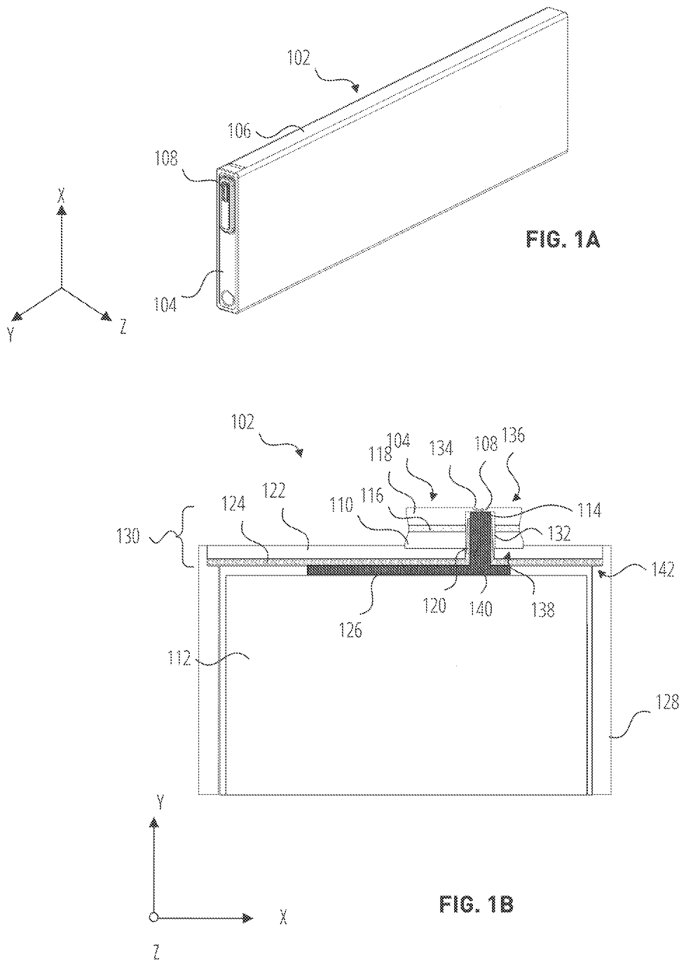

Turning now to a more detailed description of aspects of the present invention, FIG. 1A is a perspective view of a cell 102 described herein and FIG. 1B depicts a cross section view of the cell illustrating components thereof. The cell has a housing extending along a first axis (e.g., X-axis) to define a width, a second axis (e.g., Y-axis) orthogonal to the X-axis to define a height, and a third axis (e.g., Z-axis) orthogonal to the first and second axes to define a thickness.

In one or more non-limiting embodiments, the cell may comprise a housing 106 which may be a can 128, a current collector 126 disposed in the housing 106, comprising a protrusion 140 that extends along the Y-axis, and a cap assembly 130. The cap assembly 130 may comprise a terminal 104 having a top side 136, a bottom side 138, a first opening 134 at the top side, a second opening 132 at the bottom side, and a terminal partition material 206 separating the second opening 132 from the first opening 134. Particularly, a volume or diameter of the second opening may be larger than a volume or diameter of the first opening as described hereinafter.

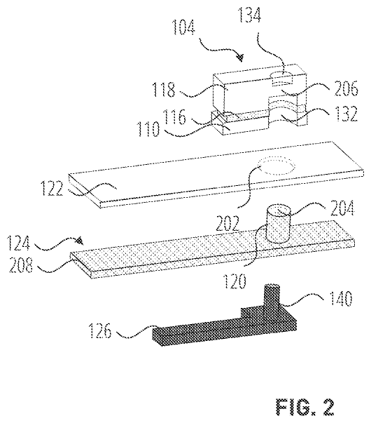

The cell 102 may also further comprise a cap plate 122 having a third opening 202 (See FIG. 2, which shows a perspective view of the cap assembly 130 and current collector 126) configured to receive the protrusion 140. The protrusion 140 may be column or pillar shaped. The current collector 126 is disposed in the second opening 132 and welded to the terminal 104 at and from the first opening 134 to form a terminal-to-current collector weld 114 at an external area of the cell. The weld may be a permanent connection that can be created not only by laser welding, friction welding, ultrasonic welding, etc., but by any connection process that physically connects material of the terminal to material of the current collector such that they are directly and electrically connected.

The current collector 126 may be connected to the electrode plate assembly 112 to charge or discharge electric energy. The can 128 seals the electrode plate assembly from the outside.

In one or more embodiments, an engraved structure 108 forms the first opening and is formed at top side 136 of the terminal. The engraved structure 108 is dimensioned to be thin relative to the second opening 132 (for example, between 0.3 mm and 1.0 mm for laser welding or between 0.5 mm and 3.0 mm for friction welding) and positioned relative to a position of the second opening 132 such that leaks, or pinholes may be prevented from being formed in the terminal partition material 206 (See FIG. 2) during welding as discussed hereinafter. The terminal partition material has a height in the Y-axis between 0.3 mm and 1.0 mm, or between 0.5 mm and 0.6 mm. In the case of friction welding of the terminal-to-current collector weld 114, the terminal partition material 206 may have a height in the Y-axis between 3-5 mm.

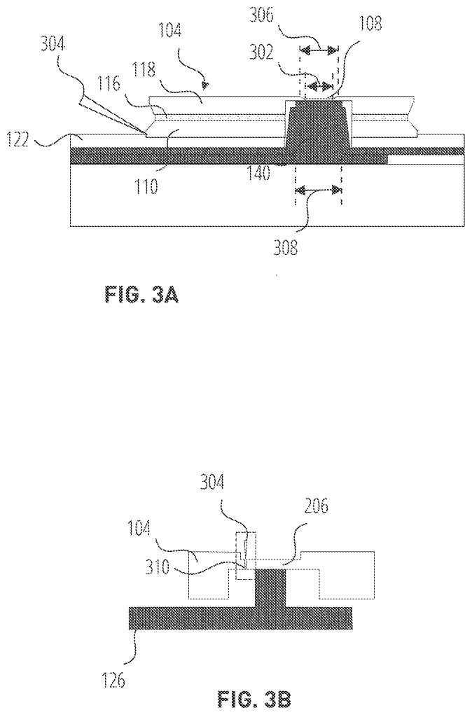

The current collector 126 is connected to the electrode plate assembly 112 at a first side of the current collector and the protrusion 140, such as a pillar-shaped protruding structure is connected to the terminal. In some embodiments, the pillar-shaped protruding structure can be manufactured as one body (unibody) with the current collector. In other embodiments, the pillar shaped protrusion can be assembled after separately fabricating the current collector base 208 and the protrusion 140. The protrusion 140 may be a pillar and have a variety of shapes such as circular, semicircular, or polygonal profile. In an embodiment, the first opening 134 is a cylindrical opening with a first diameter along the X-axis and the second opening is another cylindrical opening with a second diameter along the X-axis, and the second diameter is larger than the first diameter. In another embodiment, the first opening 134 has an upper diameter along the X-axis and a lower diameter along the X-axis, and the second opening 132 is a cylindrical opening with a second diameter along the X-axis, the second diameter being larger than the lower diameter. More specifically, a surface area of the top surface of the protrusion may be larger than the surface area of a bottom surface of the engraved structure 108. For example, as shown in the example of FIG. 3A which has a protrusion with a circular profile, a lower diameter 302 of the engraved structure 108 is smaller than the protrusion diameter 308. Further, the base of the engraved structure 108 is positioned to be inside a projection of the top surface of the protrusion 140 onto a plane of the base. Therefore, upon welding the terminal to the current collector at the base of the engraved structure 108, formation of leaks 310 in the terminal partition material 206 may be prevented. The upper diameter 306 of the engraved structure 108 may be larger or smaller that the protrusion diameter 308 as long as the terminal-to-current collector weld 114 is generated at the base of the engraved structure 108. Of course, the engraved structure 108 need not have a circular profile and can have other shapes that prevent the formation of leaks 310 in light of the descriptions herein.

In some embodiments, the terminal may comprise a unibody material made of, for example, aluminum, or may have a plurality of parts as shown in FIG. 3A wherein the terminal comprises a base plate 110, a middle insulator 116 and an upper plate 118. The base plate 110 may be welded, via a welding device 304, to the cap plate 122 to fix the terminal to the cap plate 122. To prevent the cap plate 122 from being at a same potential as a potential of the current collector, an insulator 116 may be disposed between the base plate 110 and an upper plate 118 of the terminal to electrically insulate the base plate 110 and thus the cap plate 122 from the upper plate 118 and the current collector 126. The base plate 110 and/or the upper plate 118 may be made of aluminum in some embodiments.

Turning back to FIG. 1B, the electrode plate assembly 112 and the current collector 126 may be electrically coupled and a structure for electrical insulation may be located between the electrode plate assembly and the current collector and may provide electrical isolation between negative electrodes and a positive current collector and between positive electrodes and a negative current collector.

The current collector position fixing plate 124 may be assembled to fix the current collector position. The current collector position fixing plate 124 may comprise position fixing extension 120 or other hole which forms the fourth opening 204 in which the protrusion 140 is inserted and may also allow for electrolyte and gas passage. More specifically, the current collector position fixing plate 120 may be placed in close contact with the cap plate 122, which may comprise a vent for gas emission. If a hole for emitting gas is not formed in the current collector position fixing plate, it may be difficult to emit gas through the vent in the cap plate. Accordingly, a hole for gas emission may be formed in the current collector position fixing so that the function of the vent on the cap plate is not interrupted. Further, the electrolyte is supplied into the cell through an electrolyte injection port configured on the cap plate. Therefore, a hole constructed in the plate allows electrolyte supply to be performed. The outer dimensions of a base of the current collector position fixing plate 124 may be the same as the inner dimensions of the can 128. This may prevent the current collector position fixing plate 124 from moving within the can 128. In an embodiment wherein the terminal has the base plate 110, the position fixing extension 120 may insulate the base plate 110 which is directly connected to the cap plate from current collector. Thus, the cap plate 122 may not be at the same potential as the current collector 126.

After a structure (not shown) to which the electrode plate assembly and the current collector are welded is inserted into the can 128, the position of the protrusion 140 can be adjusted and fixed by the current collector position fixing plate 124 prior to performing welding. A step structure 142 that seats the current collector position fixing plate 124 may be applied inside the can.

In some embodiments, cathode and an anode terminal can be located on the same surface or can be located on different surfaces. The terminal thickness (height in the Y-axis) may be engraved-adjusted (adjusted as at least a portion thereof by introduction of the engraved structure 108) to allow welding at the outside of battery cell. Alternatively, a hole may be formed in the terminal for face-to-face welding with the current collector and terminal, as the size and position of the hole relative to the size and position of the protrusion 140 are selected to prevent leaks 310/pinholes from being formed. Additional structures can be added on the welding region of the terminal and the current collector to ensure sealing of battery cell from ambient environment. Further, in some embodiments, if the terminal thickness (height in the Y-axis) is sufficiently thin, a terminal with a planar structure that is not engraved can be used.

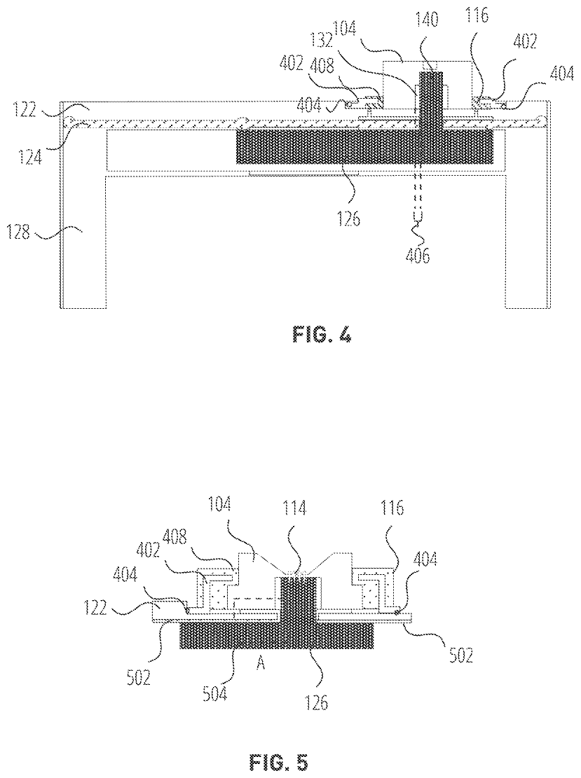

FIG. 4 illustrates an embodiment wherein the terminal 104 is unibody. The terminal 104 may be at a same potential as the current collector 126. Thus, the terminal 104 may be fixed in a defined position and electrically insulated from the cap plate 122 via another insulator 408 and bracket 402. The bracket 402 may be fixed/welded to the cap plate 122 at the bracket-to-cap plate weld 404 to fix the terminal at a defined position on the cap plate. The another insulator 408 may be disposed between the bracket 402 and the terminal 104.

In an aspect herein, the current collector position fixing plate 124 may not have a position fixing extension 120 as shown in FIG. 4. Further a clearance 406 may be provided between the walls of the protrusion 140 and the walls of the second opening 132. This may enable easy and reproducible assembly of cell components. The clearance 406 may be provided by dimensioning the second opening to have a diameter along the X-axis larger than another diameter of the protrusion along X-axis.

FIG. 5 depicts an illustrative embodiment comprising said another insulator 408 as well as a seat insulator 502. In this embodiment, a current collector position fixing plate 124 may be absent. To insulate the terminal 104 and current collector 126 from the cap plate 122, not only is said another insulator 408 used but a seat insulator 502 may additionally be disposed under the cap plate 122 and thus positioned between the current collector 126 and the cap plate as well as between the terminal and the cap plate as illustrated in region A 504.

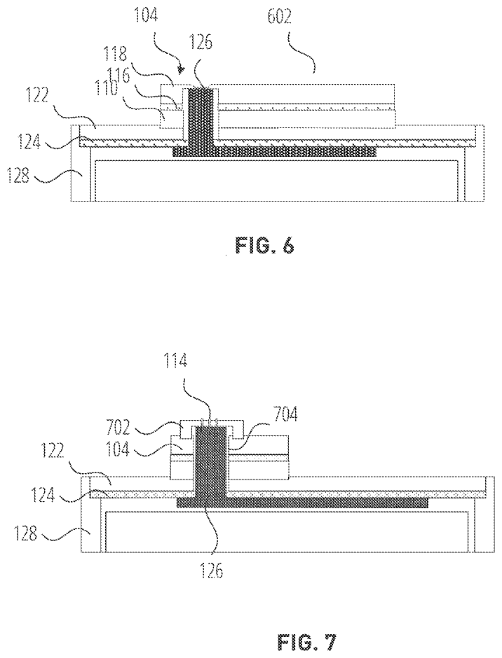

In another aspect as illustrated in FIG. 6, the terminal 104 is a non-unibody terminal comprising a plurality of parts. Unlike in the embodiments of FIG. 4 and FIG. 5 a bracket may not be necessary to fix the terminal 104 to the cap plate 122. The base plate 110 may be welded to the cap plate 122. Due to the absence of the bracket 402 and another insulator 408, a surface area 602 of the terminal can be designed to be relatively large compared to that of the terminals with the bracket and another insulator.

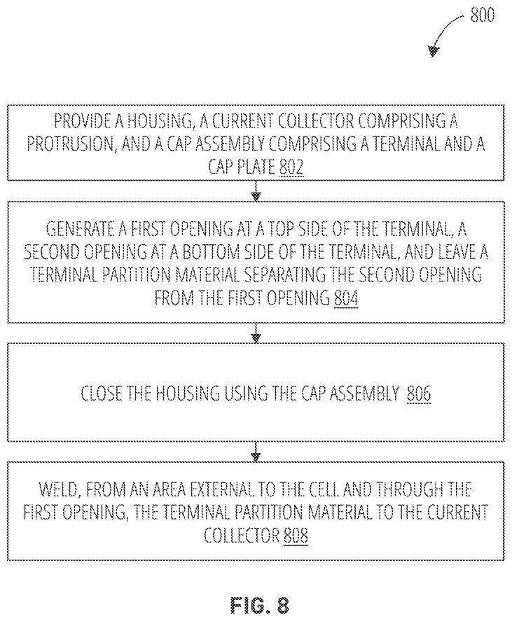

Turning now to FIG. 7, a cell comprising a terminal hole cover 702 is disclosed. The cell may have one hole 704 disposed within the terminal 104. The hole may run from the top side to the bottom side of the terminal, and a terminal hole cover covers the hole. The current collector may be disposed in the hole and welded to the terminal at the terminal hole cover 702 to form a terminal-to-current collector weld 114 at an external area of the cell. Alternatively, in some configurations the terminal hole cover 702 may be omitted or not welded to the current collector, and/or the protrusion 140 may be welded to the terminal.

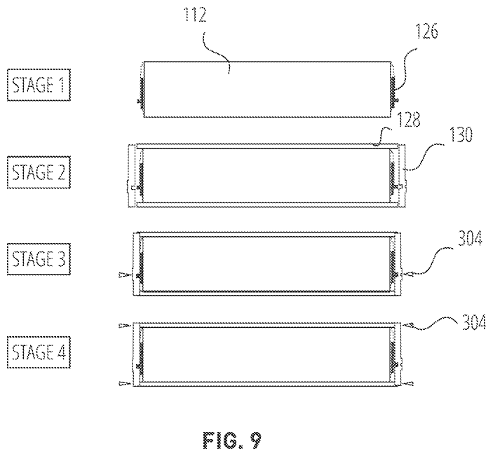

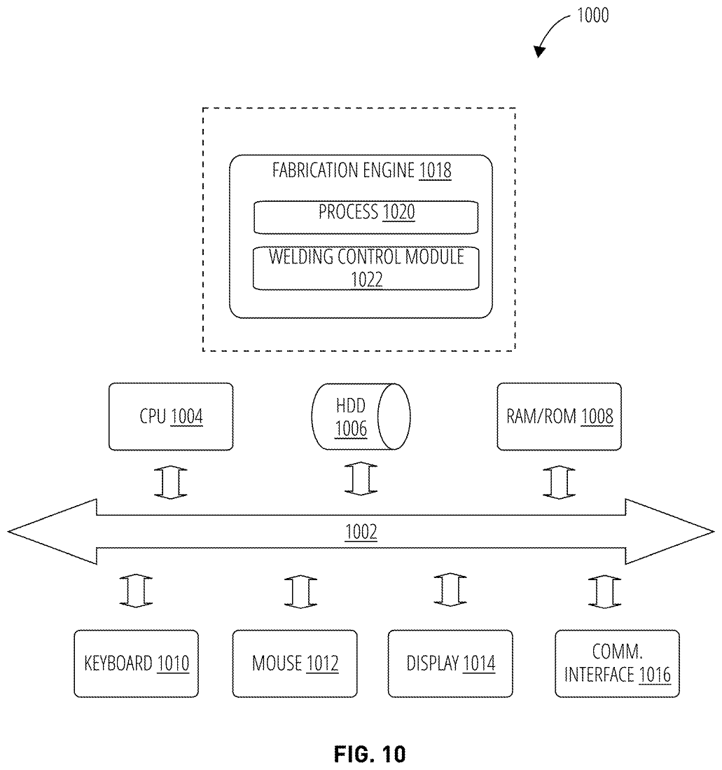

FIG. 8 depicts a routine 800 for fabricating a cell with an external welded structure. The process is illustrated the stages of FIG. 9. The routine 800 may be performed by an engine such as fabrication engine 1018 of FIG. 10. The routine 800 begins at block 802, wherein a housing 106, a current collector 126 comprising a protrusion 140, and a cap assembly 130 comprising a terminal 104 and a cap plate 122 are provided. An electrode plate assembly 112 is also provided as illustrated in STAGE 1 of FIG. 9.

In block 804, fabrication engine 1018 may generate a first opening 134 at a top side 136 of the terminal 104, a second opening 132 at a bottom side 138 of the terminal 104 and leave a terminal partition material 206 separating the second opening 132 from the first opening 134. The dimensions of the terminal partition material and second opening may be predefined with a volume or top surface area of the second opening 132 being larger than a volume or bottom surface area of the first opening 134. The fabrication engine 1018 fixes the protrusion 140 of the current collector 126 in the can 128 using the current collector position fixing plate 124.

In block 806, fabrication engine 1018 closes the housing 106 using the cap assembly 130 by inserting a protrusion 140 of the current collector into the second opening 132 to dispose it adjacent to the terminal partition material 206 (See STAGE 2, FIG. 9).

In block 808, fabrication engine 1018 welds, from an area external to the cell and through the first opening 134, the terminal partition material 206 of the terminal to the current collector 126 to generate a terminal-to-current collector weld 114 (STAGE 3, FIG. 9). The welding may be performed by laser welding, friction welding, ultrasonic welding, etc., and may be performed using the welding device 304. The routine 800 may further comprise welding the cap assembly 130 to the can 128 to close the cell as shown in STAGE 4 of FIG. 9. The cell may be a prismatic cell. However, the features described herein may also be applicable to other cell types such as cylindrical cells. Other technical features may be readily apparent to one skilled in the art from the figures, descriptions, and claims. While the components and manufacture of a cell with an external welded structure are described for the purposes of discussion, it will be understood that other configurations, as well as other fabrication processes are supported by the teachings herein.

As discussed above, functions relating to methods and systems for fabricating a cell with an external welded structure can use of one or more computing devices connected for data communication via wireless or wired communication. FIG. 10 is a functional block diagram illustration of a computer hardware platform that can be used to control various aspects of a suitable computing environment in which the process discussed herein can be controlled. While a single computing device is illustrated for simplicity, it will be understood that a combination of additional computing devices, program modules, and/or combination of hardware and software can be used as well. The computer platform 1000 may include a central processing unit (CPU) 1004, a hard disk drive (HDD) 1006, random access memory (RAM) and/or read only memory (ROM) 1008, a keyboard 1010, a mouse 1012, a display 1014, and a communication interface 1016, which are connected to a system bus 1002.

In one embodiment, the hard disk drive (HDD) 1006, has capabilities that include storing a program that can execute various processes, such as the fabrication engine 1018, in a manner described herein. The fabrication engine 1018 may have various modules configured to perform different functions. For example, there may be a process module 1020 configured to control the different manufacturing processes discussed herein and others. There may be a welding control module 1022 operative to provide an appropriate energy output and duration for welding material such as a current collector to a terminal.

For the sake of brevity, conventional techniques related to making and using aspects of the invention may or may not be described in detail herein. In particular, various aspects of computing systems and specific computer programs to implement the various technical features described herein may be well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted or modified.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A cell comprising:
a housing;
a current collector disposed in the housing, comprising a protrusion; and
a cap assembly that closes the housing comprising:
a terminal comprising a top side, a bottom side, and a hole extending from the top side to the bottom side; and
a cap plate comprising an opening configured to receive the protrusion;
wherein the current collector is disposed in the hole and welded to the terminal at the terminal hole cover to form a terminal-to-current collector weld at an external area of the cell.

2. The cell of claim 1, wherein the protrusion is a pillar shaped protrusion.

3. The cell of claim 1, wherein the terminal further comprises an upper plate, a middle insulator and a base plate, wherein the base plate is welded to the cap plate and wherein the insulator electrically insulates the upper plate from the base plate.

4. The cell of claim 3, wherein the base plate and/or upper plate comprise aluminum.

5. The cell of claim 1, wherein the terminal is electrically insulated from the cap plate by an insulator disposed between a bracket and the cap plate, wherein the bracket is welded to the cap plate.

6. The cell of claim 1, further comprising a current collector position fixing plate disposed between the cap plate and the current collector, the current collector position fixing plate comprises a fourth opening through which the protrusion is inserted.

7. The cell of claim 6, wherein the current collector position fixing plate comprises a position fixing extension along the second axis to receive and confine the protrusion.

8. The cell of claim 7, wherein the position fixing extension is configured with a fourth opening to prevent the protrusion from touching at least a portion of the terminal, wherein the terminal in not a unibody.

9. The cell of claim 1, wherein the current collector-terminal weld is a laser weld, a friction weld or an ultrasonic weld.

10. The cell of claim 1, wherein the cell is a prismatic cell.

11. A cell comprising:
a housing extending along a first axis to define a width, a second axis orthogonal to the first axis to define a height, and a third axis orthogonal to the first and second axes to define a thickness;
a current collector comprising a protrusion, the current collector disposed in the housing; and
a cap assembly that closes the housing comprising:
a terminal comprising a top side, a bottom side, a first opening at the top side, a second opening at the bottom side, and a terminal partition material separating the second opening from the first opening, a volume of the second opening being larger than a volume of the first opening; and
a cap plate comprising a third opening configured to receive the protrusion;
wherein the current collector is disposed in the second opening and welded to the terminal at the first opening to form a terminal-to-current collector weld at an external area of the cell.

12. The cell of claim 11, wherein the first opening is a cylindrical opening with a first diameter along the first axis and the second opening is another cylindrical opening with a second diameter along the first axis, and
wherein the second diameter is larger than the first diameter.

13. The cell of claim 11, wherein the first opening has an upper diameter along the first axis and a lower diameter along the first axis, and the second opening is another cylindrical opening with a second diameter along the first axis, and
wherein the second diameter is larger than the lower diameter.

14. The cell of claim 11, wherein a clearance is provided between walls of the second opening and walls of the protrusion based on dimensioning the second opening to have a diameter along the first axis larger than another diameter of the protrusion along said first axis.

15. The cell of claim 11, wherein the protrusion has a diameter along the first axis that is larger than another diameter of the first opening along the first axis and wherein the protrusion is positioned below the first opening such that no leak is formed in the terminal partition material that exposes internal components of the cell to ambient environment.

16. The cell of claim 11, wherein the terminal partition material has a height in the second axis between 0.3 mm and 1.0 mm.

17. The cell of claim 16, wherein the terminal comprises aluminum.

18. The cell of claim 16, wherein the height is between 0.5 mm and 0.6 mm.

19. A method comprising:
providing a housing, a current collector comprising a protrusion, and a cap assembly comprising a terminal and a cap plate;
generating a first opening at a top side of the terminal, a second opening at a bottom side of the terminal, and leaving a terminal partition material separating the second opening from the first opening, a volume of the second opening being larger than a volume of the first opening;
closing the housing using the cap assembly by inserting a protrusion of the current collector into the second opening to dispose it adjacent to the terminal partition material; and
welding, from an area external to the cell and through the first opening, the terminal partition material to the current collector to generate a terminal-to-current collector weld.
